(19) United States
(12) Patent Application Publication
(10) Pub. No.: US 2015/0133166 A1
(43) Pub. Date: May 14, 2015

(54) SYSTEMS AND METHODS TO ENABLE EFFICIENT RF HEAT MAPS

(71) Applicant: QUALCOMM Incorporated, San Diego, CA (US)

(72) Inventor: Stephen William EDGE, Escondido, CA (US)

(21) Appl. No.: 14/530,429

(22) Filed: Oct. 31, 2014

Related U.S. Application Data
(60) Provisional application No. 61/901,943, filed on Nov. 8, 2013.
(60) Provisional application No. 61/921,272, filed on Dec. 27, 2013.

(51) Int. Cl. H04W 4/04

(52) U.S. Cl. CPC H04W 4/043
USPC 455/456.3

(57) ABSTRACT

Systems, methods, and devices are described for aligning heat map data more efficiently to actual geometry of an area of interest. Certain embodiments make use of reorienting a rectangular array of grid points in which an additional angle parameter is added to existing parameters for a rectangular heat map. For example, the grid points may be reoriented to form a shape resembling a parallelogram.

### CROSS-REFERENCE TO RELATED APPLICATIONS

The present application claims the benefit of and priority to Provisional Application No. 61/901,943 entitled “Extension of WiFi Heat Map” filed Nov. 8, 2013, and Provisional Application No. 61/921,272 entitled “Systems and Methods to Enable Efficient RF Heat Maps” filed Dec. 27, 2013, which are assigned to the assignee hereof and expressly incorporated by reference herein.

### TECHNICAL FIELD

The present disclosure relates generally to representing data on a grid of points, and in particular, to efficiently representing and providing RF heat map data to a device.

### BACKGROUND

Generally, a location of a mobile device (e.g., a location fix or location estimate) may be determined using measurements made by the mobile device of radio signals transmitted by one or more transmitters. These transmitters may include access points, base stations and/or navigation satellites which may be situated at known or, in some cases, unknown locations. Obtaining a location fix for a mobile device has become a critically important function in recent years. For mobile devices, there are numerous applications and web-based services that take advantage of the location fix of the device. For example, a map application on a mobile device or on a remote web server can select appropriate maps, directions, driving routes, etc., based on the current location of the mobile device and, in some cases, the velocity of the mobile device. A social networking application can identify other users within the vicinity based on the location of the mobile device. Many other examples exist.

Different techniques for obtaining a position fix for a mobile device may be appropriate under different conditions. In an outdoor environment, satellite-based approaches, e.g., GNSS (Global Navigation Satellite System) techniques may be suitable, because the mobile device may be able to receive satellite-based positioning signals with specific and measurable timing characteristics that depend on the location of the mobile device. Based on reception and measurement of such satellites signals, a position fix for the mobile device may be calculated either by the mobile device or by a separate server (e.g., a location server) to which the measurements are sent. However, satellite-based approaches are not preferred in indoor environments, because satellite signals cannot always be received or accurately measured indoors.

In indoor environments, such as a shopping mall, airport, sports arena, convention center, office building, etc., terrestrial-based approaches making use of signals transmitted from cellular base stations (BSs) and/or wireless local area network (WLAN) access points (APs) are generally more useful for obtaining an accurate location fix for a mobile device. The mobile device observes and measures signals sent from BSs and/or APs which may be at known locations. Different types of signal measurements may be obtained such as RSSI (Received Signal Strength Indication), RTT (Round-trip signal propagation Time), Observed Time Difference Of Arrival (OTDOA) and the like. Such measurements may allow the mobile device or a separate location server to estimate the distance of the mobile device to each BS and/or AP and/or to estimate characteristics of the distance such as the difference in the distance of the mobile device to each of two APs or two BSs. Trilateration may then be performed to estimate the location of the mobile device, based on the distances (or differences in the distances) to different BSs and/or APs and the known locations of the BSs and/or APs.

In another example, the mobile device may compare the measured RSSI and/or measured RTT for each BS or AP to a grid of data providing the expected RSSI and/or expected RTT for a particular BS or AP at different locations of the mobile device. The mobile device may then determine its location using a number of such data grids for each of a plurality of APs and/or BSs, using a process such as pattern matching, by finding a particular location for which the expected RSSIs and/or expected RTTs according to the data grids for some among the plurality of BSs and/or APs most closely match the RSSIs and/or RTTs measured by the mobile device. In this case, the device does not need to know locations of the BSs and APs.

Indoor heat maps for Wi-Fi APs and Bluetooth® APs containing RSSI and/or RTT values are conventionally defined for rectangular areas aligned with a local X,Y coordinate system. Such rectangular areas may align moderately well with the coverage area of an AP, but may not always fit the geometry and dimensions of indoor areas. For example, there may be building corridors (e.g., at an airport) that are at an angle to the X and Y axes or there may be open areas above ground level (e.g., an atrium) that are not accessible to a user and for which RSSI and RTT values in a heat map are of no use to locate the user. Although a rectangular heat map area can still be overlaid on the accessible part of an indoor area in these cases, a significant fraction of the heat map area may end up covering inaccessible locations. As a result, unnecessary extra data corresponding to the inaccessible grid points may be sent to a device and stored in its memory. Therefore, there is a need in the art for systems and methods that align a heat map with actual geometry of an area of interest for efficient use of the resources.

### SUMMARY

Certain embodiments present a method for providing access point (AP) vicinity information. The method includes, in part, defining a plurality of grid points overlaying an area of interest, wherein the plurality of grid points form a shape resembling a parallelogram comprising vertices characterized by non-right angles, determining AP vicinity information for the plurality of grid points, and providing the AP vicinity information and at least one characteristic defining the parallelogram to a mobile device. In one embodiment, the at least one characteristic comprises an angle.

In one embodiment the plurality of grid points include, in part, rows of grid points or columns of grid points. In addition, providing the set of AP vicinity information includes, in part, mapping the plurality of grid points to form a shape resembling a rectangle by shifting rows of grid point rows or columns of grid points in one direction, and compressing the AP vicinity information corresponding to the mapped grid points.

In one embodiment, the plurality of grid points include, in part, equal number of grid points in each row of the parallelogram. In addition, the at least one characteristic includes, in part, an angle between −45 and 45 degrees.

Certain embodiments provide a method for utilizing AP vicinity information. The method includes, in part, receiving AP vicinity information and at least one characteristic from a device, wherein the AP vicinity information corresponds to a plurality of grid points overlaying an area of interest, and the plurality of grid points form a shape resembling a parallelogram comprising vertices characterized by non-right angles, and processing the AP vicinity information using the at least one characteristic.

In one embodiment, processing the AP vicinity information includes, in part, determining AP vicinity information for a plurality of grid points forming a shape resembling a rectangle by decompressing the received AP vicinity information, and mapping the plurality of grid points into the shape resembling the parallelogram by shifting rows or columns of grid points for the rectangle in one direction according to the at least one characteristic.

Certain embodiments present an apparatus for providing AP vicinity information. The apparatus includes, in part, means for defining a plurality of grid points overlaying an area of interest, wherein the plurality of grid points form a shape resembling a parallelogram comprising vertices characterized by non-right angles, means for determining AP vicinity information for the plurality of grid points, and means for providing the AP vicinity information and at least one characteristic defining the parallelogram to a mobile device.

Certain embodiments present non-transitory processor-readable medium for providing AP vicinity information. The non-transitory processor-readable medium includes, in part, processor-readable instructions configured to cause a processor to define a plurality of grid points overlaying an area of interest, wherein the plurality of grid points form a shape resembling a parallelogram comprising vertices characterized by non-right angles, determine AP vicinity information for the plurality of grid points, and provide the AP vicinity information and at least one characteristic defining the parallelogram to a mobile device.

### BRIEF DESCRIPTION OF THE DRAWINGS

An understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a wireless communication network, in accordance with certain embodiments of the present disclosure.

FIG. 2 illustrates an example reference grid with an example heat map area, in accordance with certain embodiments of the present disclosure.

FIG. 3 illustrates an example radio frequency heat map area including grid points, in accordance with certain embodiments of the present disclosure.

FIGS. 4A and 4B illustrate two example rectangular heat maps overlaying areas with inefficient overlay of grid points.

FIGS. 5A and 5B illustrate two example scanning orders for grid points, in accordance with certain embodiments of the present disclosure.

FIG. 6 illustrates an example heat map encoding, in accordance with certain embodiments of the present disclosure.

FIG. 7 illustrates an example reorientation of a heat map area with rows shifted in the positive X direction, in accordance with certain embodiments of the present disclosure.

FIG. 8 illustrates an example reorientation of a heat map area with columns shifted in the positive Y direction, in accordance with certain embodiments of the present disclosure.

FIG. 9 illustrates example operations that may be performed by a device to provide a heat map, in accordance with certain embodiments of the present disclosure.

FIG. 10 illustrates example operations that may be performed by a mobile device to utilize heat map information, in accordance with certain embodiments of the present disclosure.

FIG. 11 describes one potential implementation of a device which may be used to provide and/or utilize a heat map, according to certain embodiments.

### DETAILED DESCRIPTION

Certain embodiments of the present disclosure provide a method for efficiently aligning vicinity information (e.g., Wi-Fi or Bluetooth radio frequency (RF) heat map data) of an access point (AP) to actual building geometry. The AP vicinity information may generally relate to any information that is dependent on geographic location (e.g., a geographic location matching one among a set of grid points) within the vicinity of the AP. For example, the vicinity information may include AP radio signal strength indication information (e.g., RSSI), AP round trip propagation time values (e.g., RTT), or any data related to RF signal transmission from the AP that can be calculated or measured for a location close to the AP. The information may be in the form of mean values, standard deviation values and/or other statistics. In one embodiment, the AP vicinity information may be used in obtaining a location fix for a mobile device in an indoor environment. Generally, a location fix is a position derived from measuring signals transmitted from identifiable transmitters at known or unknown locations.

As used herein, the term “access point” includes any wireless communication station and/or device, typically installed at a fixed terrestrial location and used to facilitate communication in a wireless communications system. For example, an access point may comprise a wireless local area network (WLAN) access point, a cellular base station, Macro cell, Macro base station, Pico cell, Pico base station, Femto cell, Femto base station, eNode B, Node B, home NodeB or the like. The AP may support wireless communication and transmission according to any of a number of different wireless communication standards such as Global System for Mobile Communications (GSM), Wideband Code Division Multiple Access (WCDMA), Long Term Evolution (LTE), Wi-Fi, Bluetooth, code division multiple access 2000 (cdma2000) or some other standard. Wireless communication using GSM, WCDMA and LTE is defined by an organization known as the 3^{rd} Generation Partnership Project (3GPP). Wireless communication according to cdma2000 is defined by an organization known as the 3^{rd} Generation Partnership Project 2 (3GPP2) and wireless communication using Wi-Fi is defined by the Institute of Electrical and Electronics Engineers (IEEE).

As used herein, the terms “user equipment” (UE), “device” or “mobile device” may be used interchangeably to refer to a device that may from time to time have a position location that changes. For example, a mobile device may comprise a cellular telephone, smartphone, tablet, wireless communication device, mobile station, laptop computer, a personal communication system (PCS) device, Secure User Plane Solution (SUPL) Enabled Terminal (SET), personal digital assistant (PDA), personal audio device (PAD), portable navigational device, and/or other portable communication devices.

Certain embodiments present a method for aligning heat map information with actual geometries of an area of interest and providing the heat map information to a mobile device (e.g., user equipment). The heat maps may then be used by the mobile device to determine its location. While the vicinity information is described for WLAN or Wi-Fi APs, the same method of representing the information may be used for other transmitters such as cellular BSs, small cells and small BSs, Bluetooth APs, and the like.

Generally, AP vicinity information (also referred to as an RF heat map, or a heat map) is a graphical representation of data where the individual RF signal characteristics (e.g., mean RSSI, mean RTT and the like) are contained in a matrix associated with a set of grid points such as a set of grid points containing rows and columns corresponding to a rectangle. The AP vicinity information may be depicted with a set of colors and/or numbers. As an example, the magnitude of a signal characteristic at any grid point may be represented by a specific color around that grid point, or a specific number associated with the grid point.

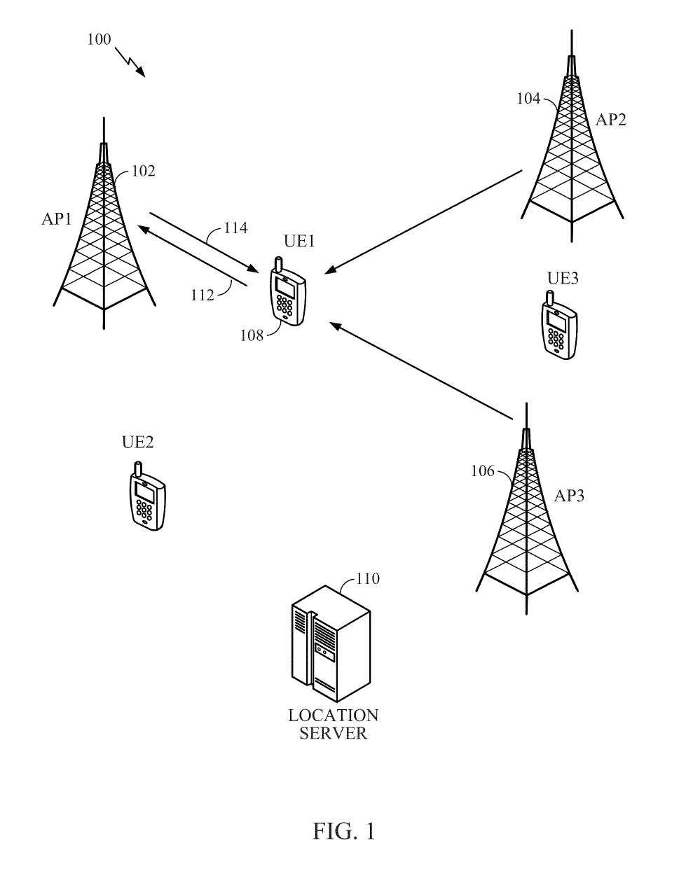

FIG. 1 illustrates a wireless communication network 100, in accordance with certain embodiments of the present disclosure. As illustrated, the network 100 may include a plurality of access points (e.g., AP1 102, AP2 104, AP3 106) and user equipments (e.g., UE1 108, UE2, UE3). In addition, the network 100 may include or provide access to a location server (LS) 110. UE1 communicates with its serving access point (e.g., AP1 102) through a forward link 112 and a reverse link 114. UE1 may also receive signals from other access points (e.g., AP2 104 and/or AP3 106). It should be noted that although only a few UEs and APs, and only one LS are illustrated in FIG. 1, any number of these devices may be available in the network or (in the case of an LS) may be accessible from the network.

Location server 110 stores and/or determines signal strength information and/or timing information corresponding to different access points (e.g., Wi-Fi heat maps) for a grid of points specific to each access point. LS 110 provides this information to the UEs and/or other devices. In general, each of the access points may have a grid of points associated with it that may span a horizontal geographic area corresponding to the overall wireless coverage area of the access point. If an access point can provide wireless coverage to several floors of a multi-story building (e.g., the floor on which the access point is located as well as the floor immediately above and the floor immediately below this floor), the access point may have a separate grid a points for each floor for which wireless coverage can be provided where the grid of points for each floor corresponds roughly to the geographic area for the floor within which wireless coverage by the access point can be provided.

Signals transmitted by an access point may be measured by a device (e.g., by UEs such as UE1, UE2 and UE3 and/or by other mobile devices), with the measurements provided to the LS 110 to enable the LS 110 to compute a location for the device based on the measurements. Alternatively, location server 110 or another device may generate one or more heat maps by computing expected signal measurements corresponding to each AP for the set of grid points or for each of the sets of grid points associated with the AP based on a local building layout, a known AP location, known RF propagation laws, and other characteristics. The heat maps may be stored in the LS or any other nodes in a wireless communication system and provided to the UEs in the vicinity of the APs. In addition or as an alternative, location server 110 may receive measurements of AP signals (e.g., measurements of RSSI and/or RTT) for one or more APs from one or more UEs at known locations, where the locations of the UEs are also provided to the location server 110. The known locations of the UEs may be obtained by each UE (or by the location server 110) using position methods not dependent on the signals measurements for the APs. For example, the known UE locations may be obtained using GNSS measurements obtained by each UE and may be updated as the UE moves to other locations using additional GNSS measurements. Alternatively or in addition, a new location for a UE may be obtained using measurements obtained by inertial sensors (e.g., accelerometers, gyroscopes, magnetometers and/or barometers inside each UE) which may suffice to determine a change in location for a UE and thereby update a previous location that was obtained using GNSS. A location server 110 may use the measurements (e.g., of RSSI and/or RTT) received for each AP from UEs at different known locations to create, update and/or validate a heat map of signal measurements (e.g., for RSSI and/or RTT) corresponding to a grid of points (or several grids of points) overlaying the coverage area (or coverage areas) for the AP.

Generally, a heat map for an AP is defined based on a set of grid points arranged (e.g., in a rectangular shape) relative to a horizontal X, Y coordinate system, which may have any orientation relative to a fixed North-South-East-West coordinate system. The X, Y coordinate system plus a grid point spacing (which provides a unit of length) may be used (e.g., by a location server such as LS 110) to define a common reference grid for most or all of the heat maps for a set of APs that provide wireless coverage in some common area or volume (e.g., such as an office building, apartment building, airport, convention center). The common reference grid may contain one grid point at the origin of the X, Y coordinate system and additional grid points at every location in the X, Y coordinate system that has integer X and Y coordinates, where the common grid point spacing provides the unit of length for the X and Y coordinates. Thus, for example, there may be grid points for locations with coordinates (X=1, Y=1), (X=2, Y=2) etc. but not at locations where an X or Y coordinate is not an exact integer. An individual heat map for a particular Wi-Fi AP (or a Femto cell) in a particular building or area may then be defined by a rectangle. The location, length and width of the rectangle can be defined using the common reference grid. For example, a rectangular set of grid points within the common reference grid may be defined by specifying integer X and Y coordinate values of one corner of the rectangle (e.g., the corner with minimum X and Y coordinate values) as well as the number of grid points in the common reference grid that appear inside the rectangle in the X and Y directions. Data corresponding to each heat map (e.g., mean RSSI, mean RTT) may then be provided for each grid point within the rectangular heat map area as a sequence of bits or octets. The heat map data may optionally be compressed using a compression method, such as JPEG.

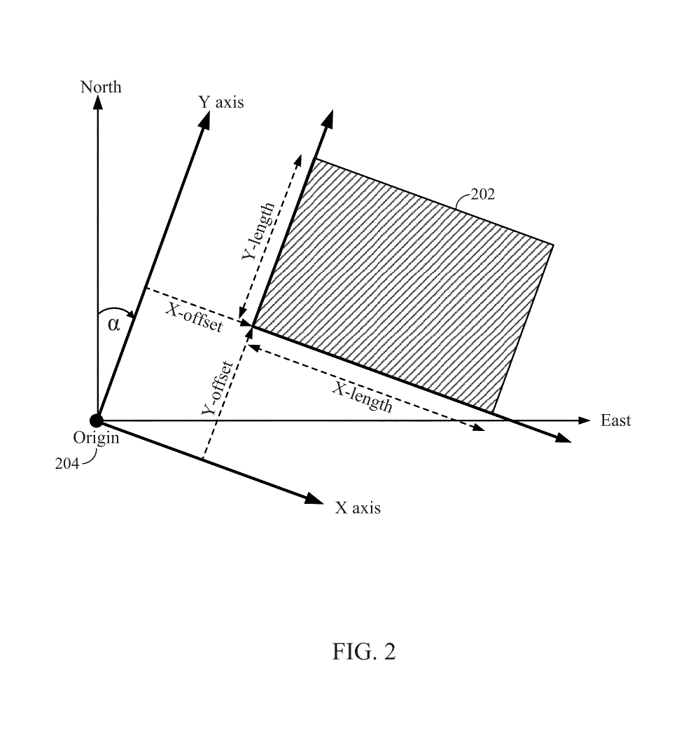

FIG. 2 illustrates an example reference grid with an example (RF) heat map area 202. The heat map area 202 is defined relative to a reference grid. The reference grid may correspond to the common reference grid described previously and in the example in FIG. 2 is a two dimensional horizontal X, Y coordinate system with a given origin 204, given orientation a and given grid point spacing (not shown in FIG. 2). The origin 204 of the X, Y coordinate system may coincide with one grid point and may be defined as a location relative to a reference point (e.g., a location that coincides with a reference point or a location that is North (or South) of the reference point by a given distance and East (or West) of the reference point by another given distance). The reference point may be a point with a predefined location, such a predefined latitude and longitude, or a point with a predefined position on a map or on a building floor plan (e.g., the center of an entrance to a building or particular corner of a building). The orientation a may represent a clockwise (or counter-clockwise) angle between North (or East, West or South) and the Y axis (or X axis). X and Y coordinates may be restricted to integers based on the common grid spacing (e.g., where a Y coordinate of 1 corresponds to locations with a perpendicular distance equal to the common grid point spacing from the X axis). The grid spacing may be defined as a distance between adjacent grid points in X and/or Y directions. Heat map area 202 may be defined as a rectangle with sides parallel to the X and Y axes. The location of the heat map area 202 may be defined by the X and Y coordinates (denoted X-offset and Y-offset in FIG. 2) of the corner of the rectangle with minimum X and Y coordinates, where the X and Y coordinates may be restricted to be integers to ensure that the corner of the rectangle with minimum X and Y offsets coincides with a grid point. The size of the heat map may be defined by the length of each side of the rectangle (denoted X-length and Y-length in FIG. 2) in units of the common grid spacing where both lengths may be integers to ensure that the other corners of the rectangle coincide with grid points and that each side of the rectangle aligns with a set of grid points parallel to the X or Y axis.

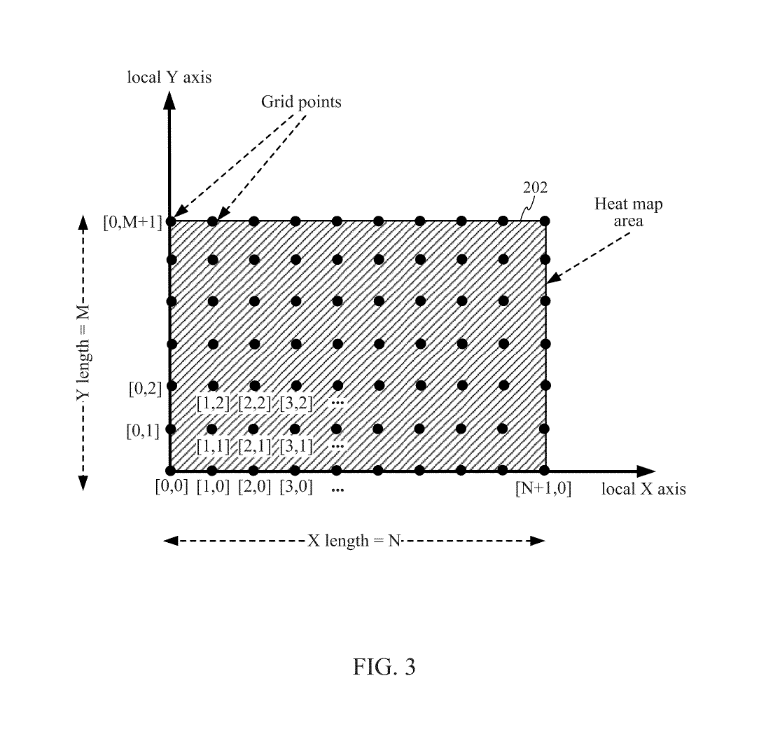

FIG. 3 illustrates an example (RF) heat map area including grid points which may correspond to heat map area 202 on FIG. 2. In this example, the length of the heat map in the X direction is represented by a positive integer N, and length of the heat map in the Y direction is represented by a positive integer M. As a result, the heat map area contains (N+1)×(M+1) grid points. Grid points align with integer X and Y coordinates in the reference grid and may be given local coordinates relative to the corner of the rectangle with minimum X, Y coordinates in the reference grid (as shown in FIG. 3). Heat map data (e.g., mean RSSI, mean RTT) are measured and/or calculated for each of the grid points.

Once a common reference grid has been defined (or is known in some way), a heat map area, such as heat map area 202 in FIGS. 2 and 3, that contains a plurality of grid points in the common reference grid, may be referred to as an array of grid points, a grid point array or, when the shape is rectangular as FIGS. 2 and 3, as a rectangular array or a rectangular array of grid points. It should be understood that a grid point array or array of grid points may overlay a heat map area and vice versa making the differing names synonymous.

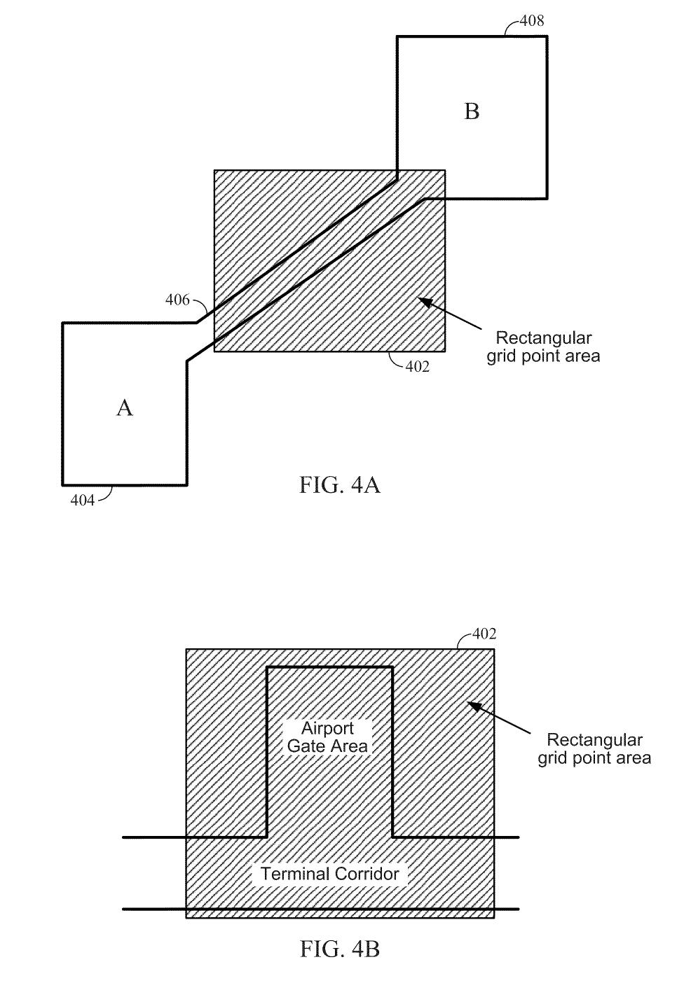

Generally speaking, the rectangular heat map definition may have some limitations. For example, a rectangular area (e.g., fixed X, Y coordinate system with a fixed orientation) may not always align well with different parts of a building and/or with different building and room geometries. For example, a connecting corridor or a connecting gate in an airport may not align with a rectangular heat map (as illustrated in FIGS. 4A and 4B). However, despite misalignment, a rectangular area may be a fairly good fit to the overall RF coverage area of an AP. Hence, indoor areas are conventionally overlaid with rectangular heat map areas. However, a substantial amount of the heat map area may not cover the area of interest (e.g., the indoor area). This may result in poor compression of the heat map data and possibly waste of resources, such as signaling bandwidth and/or memory.

FIGS. 4A and 4B illustrate two example rectangular heat maps with inefficient overlay of grid points on the areas of interest. FIG. 4A illustrates a rectangular heat map 402 overlaying a corridor (or bridge) 406 between rooms A 404 and B 408 of a building. As can be seen, only a fraction of the grid points cover the area of interest (e.g., corridor 406). Similarly, FIG. 4B illustrates a rectangular heat map 402 that inefficiently overlays a gate and part of a corridor in an airport terminal. As can be seen, only a portion of the rectangular heat map covers the gate and the corridor.

### Encoding Heat Map Values Without Compression

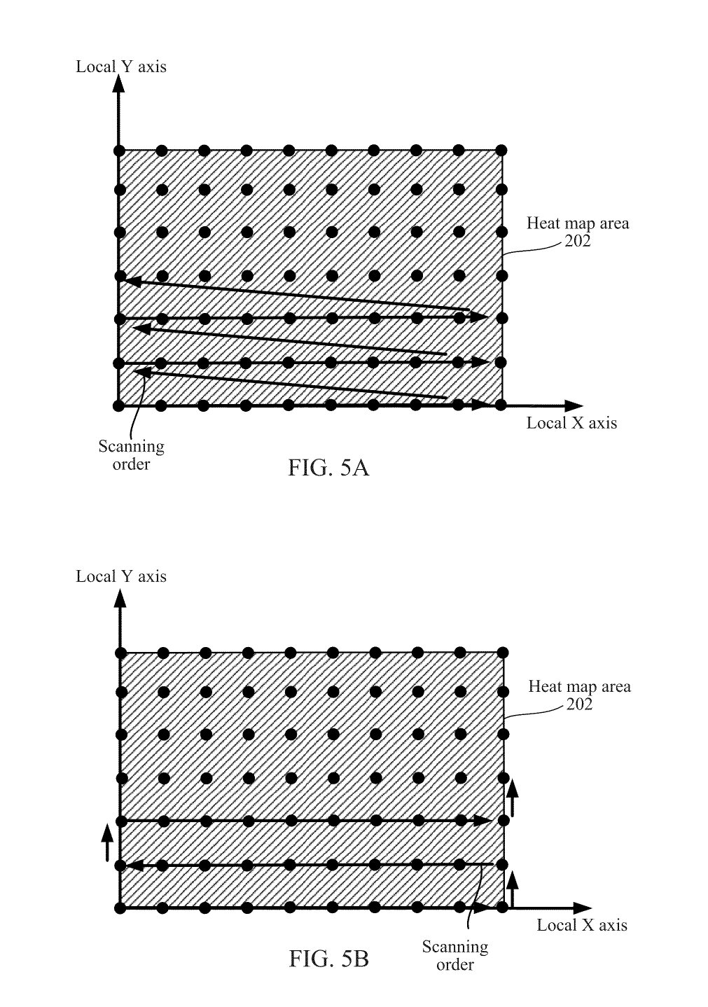

In one embodiment, heat map values may each be encoded using a single octet, containing an integer value between θ and 255. The relationship of each encoded value to the RF-related statistic (e.g., mean RSSI and/or mean RTT) may be defined in advance (e.g., an encoded value of N for RSSI might represent an RSSI value of N−128 in units of dBm). Encoded values may be provided as an octet string for successive grid points within a rectangular heat map area using a scanning order, such as the scanning orders in FIGS. 5A and 5B. The scanning order refers to an order in which grid points are encountered or “scanned”, where the scanning of each grid point corresponds to adding one or more octet values corresponding to an RF related statistic (e.g., mean RSSI or mean RTT) to the octet string. Once all grid points in a heat map area have been scanned, the resulting octet string may be used to represent all the heat map values within the heat map area—e.g., may be further compressed into a smaller octet string (e.g., using JPEG compression) and/or may be transmitted (as an uncompressed octet string) to some other entity in order to transfer the heat map content.

FIGS. 5A and 5B illustrate two example scanning orders for a set of grid points within a rectangular heat map area (such as heat map area 202 in FIGS. 2 and 3), in accordance with certain embodiments of the present disclosure. In the scanning order shown in FIG. 5A, scanning begins at the grid point with minimum X and Y coordinates in the set of grid points, and proceeds to subsequent grid points along the local X axis (e.g., row of grid points). When the last grid point within the heat map area along the local X axis is reached, scanning resumes again from low X to high X for the next row of grid points (e.g., grid points with Y coordinates equal to the Y coordinates of the previous row plus one). This continues until all the grid points with maximum Y coordinates in the heat map area are scanned from low X to high X.

FIG. 5B illustrates an alternate scanning order for the set of grid points. As illustrated, scanning begins at the grid point with minimum X and Y coordinates in the set of grid points and proceeds to subsequent grid points along the local X axis. When the last grid point within the heat map area along the local X axis is reached, scanning resumes from high X to low X for grid points in the next row (e.g., subsequent Y coordinates). This continues until grid points with maximum Y coordinates in the heat map area are scanned from either low X to high X, or high X to low X.

It should be noted that the embodiments as described herein may operate with any scanning order. FIGS. 5A and 5B only show two example scanning orders, but other orders are possible too (e.g., scanning along columns of grid points in the Y direction rather than along rows of grid points in the X direction). The scanning order may be predefined for the devices that encode and/or decode the information corresponding to the grid points.

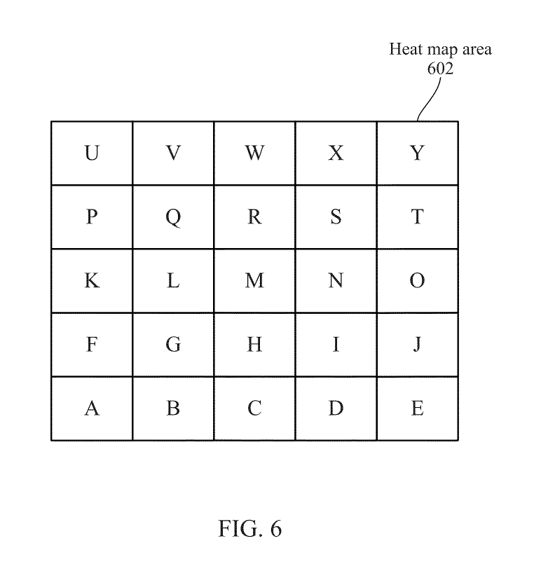

FIG. 6 illustrates an example heat map encoding, in accordance with certain embodiments of the present disclosure. A heat map area 602 of size 5 by 5 units is illustrated, where the letter within each square represents the encoded value of one particular signal statistic (e.g., mean RSSI or mean RTT) at a grid point centered within the square. As an example, the octet string that would be produced following scanning of the grid area shown in FIG. 6 using the scanning order shown in FIG. 5A would be the alphabetic sequence A, B, C, D, E, F, G . . . X, Y. As another example, if the scanning order shown in FIG. 5B is used, the scanned sequence would be A, B, C, D, E, J, I, H, G, F, K, L, M, N, O, T, S, R, Q, P, U, V, W, X, Y.

Encoding of a Heat Map with Compression

In one embodiment, a heat map containing a rectangular grid of points with a certain signal characteristic (e.g., RSSI or RTT) associated with each grid point may be compressed using known compression techniques. For example, two-dimensional image-based compression techniques such as JPEG may be used to compress the heat map data. Each of the grid points may be associated with an octet of data that represents a common signal characteristic (e.g., RSSI or RTT) at that grid point. The octet values for nearby grid points may be strongly correlated with one another due to the tendency of a signal characteristic to change only slowly with small changes in location. Therefore, a standard JPEG compression library may be used to efficiently compress the two-dimensional array of encoded octet values using the known X and Y lengths of the heat map area. The resulting compressed heat map information may then be used and/or transmitted to one or more devices. The receiving device may decompress the heat map information before use to retrieve uncompressed data. In one example, the receiver may also use standard JPEG decompression routines. Since the compression and/or decompression result in small errors, the compressing device may limit the amount of compression.

One method to enable more efficient overlay of actual building areas with heat maps is to define heat maps using more than one X, Y coordinate system. For example, in the building shown in FIG. 4A, a different X, Y reference grid can be used with the X or Y axis aligned to the direction of the corridor. This way, a rectangle could be used with a close fit to the area covered by the corridor. However, having more than one X, Y reference grid would mean misalignment of grid points in areas where coverage of several APs defined according to two or more different X, Y reference grids overlap. Aligning the grid points used for the heat maps of different APs may be useful or even necessary to better enable a mobile device or a server to determine a location for the mobile device by matching signal characteristics for the APs measured by the mobile device with the signal characteristics defined by the heat maps. If grid points do not align, it may be more difficult to compare signal characteristics for different APs for precisely the same locations.

Another method would be to use a single X, Y reference grid to maintain common grid points for all heat maps and change the rectangular shape of a heat map. Arbitrary shapes could be defined containing reference grid points (e.g., a rectangle with any orientation, circle, ellipse, etc.) but defining and using these shapes would add complexity since the shapes would need to be defined in some way which would require additional information as well as a capability to create and interpret this information. However, allowing a limited number of additional shapes that can be defined using very little additional information may be used efficiently as described next herein.

### Non-Rectangular Heat Maps

Non-rectangular heat maps conforming to certain rules described later herein may be used to overlay areas of interest with arbitrary shapes more efficiently. For example, areas that are not aligned with fixed X and Y directions for a rectangular grid may be overlaid with the non-rectangular heat maps. One embodiment enables reorientation of a rectangular area to better match an area of interest. As an example, the rectangular heap may be reoriented to form a shape resembling a parallelogram. Generally speaking, reorienting a heat map area (e.g., into a parallelogram) may allow orientation of the heat map with arbitrary building directions—e.g., the corridor 406 in FIG. 4A. One of the advantages of reorienting heat maps to non-rectangular forms, as described herein, is that the new area only adds one new parameter (e.g., an angle θ with which the rectangular map is skewed into a parallelogram). Depending on the area of interest, this method can significantly increase heat map efficiency.

For certain embodiments, a common reference grid with a common grid point spacing may be used for different APs, thereby avoiding multiple non-overlapping reference grids. It should be noted that the embodiments described herein can be used separately, or in combination without departing from the teachings of the present disclosure. In addition, the embodiments described herein may be combined with other encoding and/or compression techniques.

### Reorientation of a Heat Map

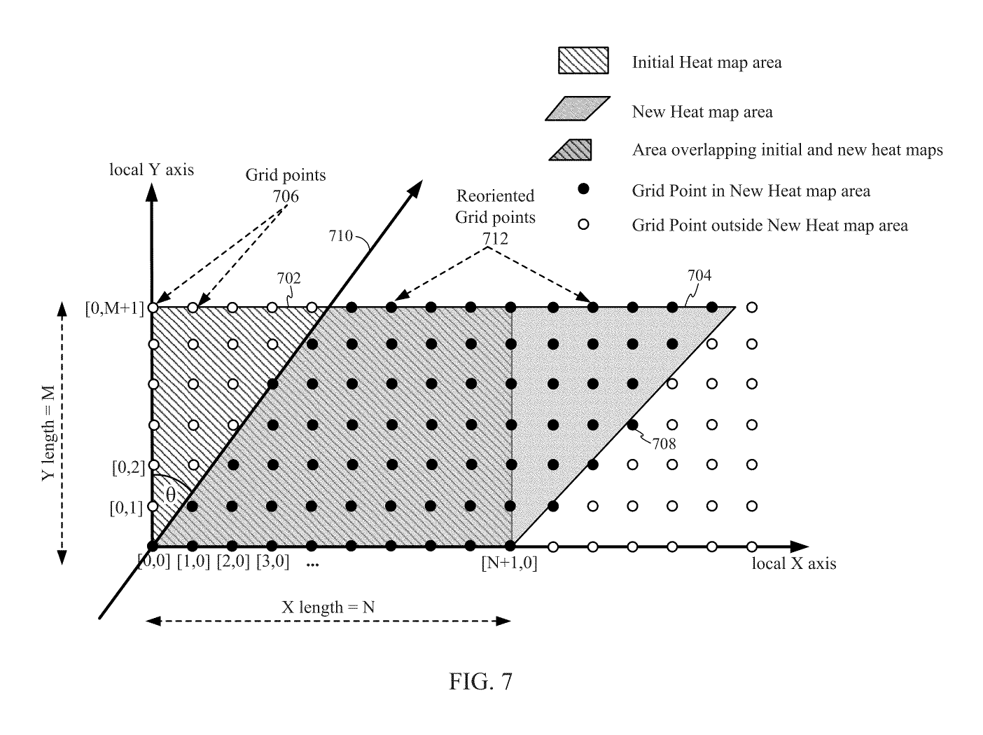

To support arbitrary reorientation of a heat map, an initial heat map area 702 composed of a rectangular array of grid points may first be defined (as shown in FIG. 7). In one embodiment, consecutive grid points may have equal distance from each other. In one embodiment, a straight line 710 through the local origin of the heat map at a clockwise angle θ to the local Y axis may be defined with −90°≦θ≦90°. Grid point rows (e.g., grid points parallel to the local X axis) in the initial heat map area may then be shifted in the positive X direction when θ is positive (as shown in FIG. 7) or in the negative X direction when θ is negative (not shown in FIG. 7) by an integer number of inter-grid point units of distance, such that each row starts at a grid point that is located either on the straight line 710 or just to the positive X side (e.g., right) of the line.

FIG. 7 illustrates an example reorientation of a heat map area with rows shifted in the positive X direction, in accordance with certain embodiments of the present disclosure. As illustrated, an initial heat map area 702 with a shape resembling a rectangle is considered. The grid points 706 of the rectangular heat map area 702 are arranged in M+1 rows and N+1 columns, where M is the length of the rectangular area parallel to the Y axis and N is the length parallel to the X axis, both in units of the common inter-grid point spacing. As described earlier, and as shown in FIG. 7, the grid points 706 in the rectangular heat map area 702 (also referred to herein as a rectangular array of grid points) may be shifted in a positive X direction to overlay a new heat map area resembling a parallelogram 704. The new reoriented heat map area (also referred to herein as a reoriented array of grid points) still contains M+1 rows of grid points parallel to the X axis. In one embodiment, each row of the reoriented heat map still contains an equal number of grid points, equal to N+1 in this example.

As shown in FIG. 7, all of the reoriented grid points 712 for the new heat map area may not fit exactly inside the parallelogram 704, but, the reoriented grid points 712 may still resemble the parallelogram 704. For example, some of the reoriented grid points (e.g., such as the grid point 708) may be located slightly outside the parallelogram 704, but close to the edges of the parallelogram 704. In general, most of the reoriented grid points may be located inside the parallelogram area 704. In this case, it is said that the grid points in the reoriented heat map area form a shape resembling a parallelogram.

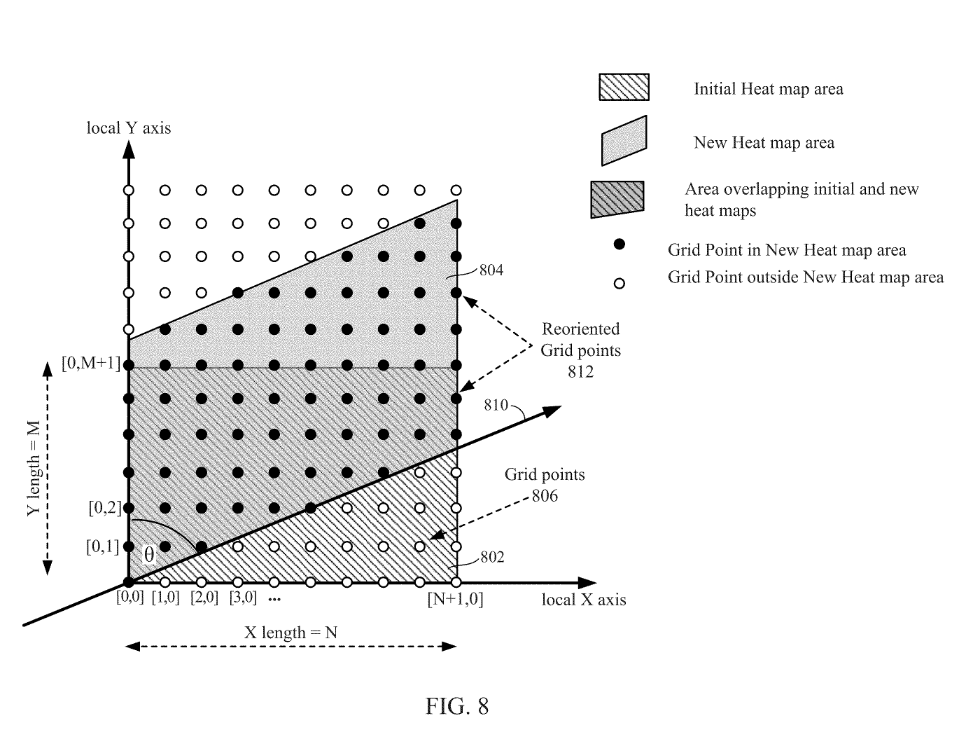

FIG. 8 illustrates another example reorientation of a heat map area composed of a rectangular array of grid points. Similar to FIG. 7, an initial heat map area 802 with a shape resembling a rectangle is considered. The grid points 806 of the rectangular heat map area 802 are again arranged in M+1 rows and N+1 columns, where M is the length of the rectangular area parallel to the Y axis and N is the length parallel to the X axis, both in units of the common inter-grid point spacing. In one embodiment, a straight line 810 through the local origin of the heat map at a clockwise angle θ to the local Y axis may be defined with −90°≦θ≦90°. However, in FIG. 8, columns of grid points 806 are shifted in the positive Y direction when θ is positive (as shown in FIG. 8) and in the negative Y direction when θ is negative towards the portion of the line 810 lying below the X axis (not shown in FIG. 8), in accordance with certain embodiments of the present disclosure. As illustrated, grid point columns (e.g., grid points parallel to the local Y axis) are shifted in the positive (or negative) Y direction by an integer number of inter-grid point units of distance such that each column starts at a grid point that is either located on the line 810 or just to the positive Y side of the line 810 (e.g., above it). In this example, all the columns of the reoriented grid points have equal number of grid points.

As shown in FIG. 8, the reoriented grid points 812 for the new heat map area may approximately fit inside the parallelogram 804, similar to the reoriented grid points 712 in FIG. 7 approximately fitting inside the parallelogram 704. In this case, it is said that the grid points 812 in the reoriented heat map area form a shape resembling a parallelogram. The difference between the parallelogram 704 in FIG. 7 and the parallelogram 804 in FIG. 8 is that two sides of the parallelogram 704 are parallel to the X axis whereas two sides of the parallelogram 804 are parallel to the Y axis. The remaining two sides of each parallelogram are parallel to the line 710 or 810 through the local origin. The clockwise angle θ of the line 710 or 810 relative to the local Y axis provides a direction or orientation for each parallelogram that may be used (e.g., may be varied) to align with a certain direction in a local geographic area—e.g., could be aligned with the direction of the corridor 406 in the example of FIG. 4A. This may allow one or both of parallelograms 704 and 804 (and thus one or both of associated reoriented grid points 712 and 812 that approximately fit inside each parallelogram) to better fit some geographic area of interest such as corridor 406 in FIG. 4A. It should be noted that there is no need for a perfect match between the orientation of the grid points and orientation of the area of interest. Even an approximate overlap may increase efficiency of the heat map representation.

In general, shifts of grid points in any direction (e.g., X and/or Y) may be allowed, though only one can be used for any one heat map, as illustrated in FIGS. 7 and 8. The new heat map area in each case is a shape roughly resembling a parallelogram. The new shifted grid points may allow a better fit with areas with similar orientations to the grid points (e.g., such as a room or corridor in a building with the same orientation θ), or substantially similar orientations (e.g., a room with an orientation θ₁ which is close to θ).

For certain embodiments, heat map values (e.g., RSSI) may be assigned to each grid point in the new (reoriented) heat map area using one or more octets. In one embodiment, the heat map values are assigned to each grid point using a single octet to encode values of some signaling characteristic (e.g., mean RSSI or mean RTT). The assignment may be based on the location of each grid point in the new reoriented heat map area and may not be related to the location of each grid point prior to reorientation of the heat map area. Heat map values may then be assembled into an uncompressed octet string. In one embodiment, the octet string may be generated by first shifting rows or columns of grid points in the reoriented heat map area back into the initial rectangular heat map area (e.g., using a reverse transformation to that shown in FIGS. 7 and 8). Although the grid points are shifted back into the original rectangular heat map area, the octet assigned to each grid point to encode a signaling characteristic may not be changed. Thus, grid point positions may change but the encoded values associated with each grid point may not change. The transformed (rectangular) heat map may then be scanned in a predetermined order (e.g., as shown in FIGS. 5A and 5B) to provide a string of heat map octet values. The string of heat map octet values may then be transferred to a target (e.g., a mobile device) along with the orientation θ, and an indication of whether rows or columns of grid points were shifted. In addition, characteristics of the original rectangular grid point array may also be provided to the target. Characteristics of the original rectangular grid point array may include the location of one corner, an orientation of the local X and Y axes, an inter-grid point spacing and the lengths of the rectangular grid in the local X and Y directions (e.g., in units of the inter-grid point spacing). In one embodiment, the reoriented heat map area may be transformed back into the original rectangular heat map area before compression is applied. For example, following the transformation back into the original rectangular heat map area, octet values assigned to each grid point to encode some signaling characteristic may be compressed using JPEG.

In one embodiment, to achieve a high compression ratio without significant error, for values of θ between −45° and 45°, rows of grid points may be shifted in the positive or negative X direction as described in association with FIG. 7. In this embodiment, for values of θ between −90° and −45°, and for values of θ between 45° and 90°, columns of grid points may be shifted in the positive or negative Y direction as described in association with FIG. 8. With this embodiment, neighboring grid points may remain close to each other after the initial shifting operation that transforms a rectangular heat map area into an area resembling a parallelogram and after the reverse transformation that transforms the approximate parallelogram shaped heat map area back into the original rectangular area for the purpose of conveying and possibly compressing encoded values for a signaling characteristic in the heat map. Thereby a high correlation of neighboring heat map values may be retained in the rectangular array following the reverse transformation, which may enable efficient compression—e.g., using JPEG. In addition, when this embodiment is used, it may not be necessary to convey to a recipient of an encoded heat map (e.g., a mobile device) whether rows or columns of grid points were shifted, because the provision of the clockwise angle θ will define this according to the convention described above. For example, if θ is given as 20°, then rows of grid points would have been shifted in the positive X direction and if θ is given as −70° then columns of grid points would have been shifted in the negative Y direction.

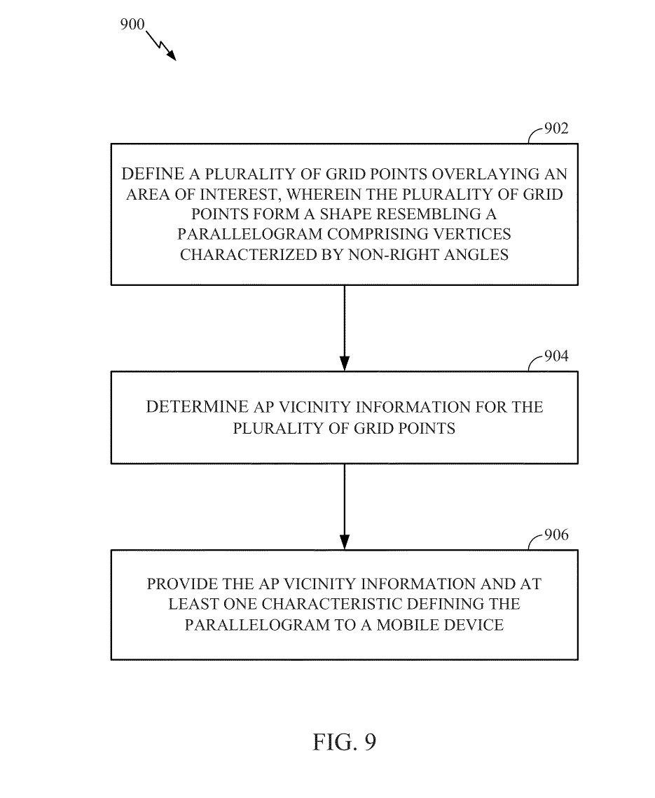

FIG. 9 illustrates example operations of a process 900 that may be performed by a device such as a location server (e.g., LS 110 in FIG. 1) to provide a heat map, in accordance with certain embodiments of the present disclosure. At 902, a plurality of grid points overlaying an area of interest may be defined. The plurality of grid points form a shape resembling a parallelogram including vertices characterized by non-right angles (e.g., angles θᵢ, 0<θᵢ<90°. or 90°<θᵢ<180°). For example, the plurality of grid points may be obtained by transforming a rectangular array of grid points as described in association with FIGS. 7 and 8. At 904, AP vicinity information is determined for the plurality of grid points. The AP vicinity information may comprise a signaling characteristic (e.g., mean RSSI or mean RTT) for a particular AP that is measured and/or computed for the location of each grid point in the plurality of grid points. The AP vicinity information may be encoded using one or more octets—e.g., may be encoded using a single octet to represent a value for a mean RSSI or mean RTT. At 906, the AP vicinity information and at least one characteristic defining the parallelogram (e.g., an angle) is provided to a mobile device. As an example, the plurality of grid points may be transformed into a rectangular array and the AP vicinity information may be scanned to produce an uncompressed octet string or may be compressed (e.g., using JPEG) into a smaller octet string with the resulting octet string being transferred to the mobile device as described previously herein (e.g., in association with the description of FIGS. 7 and 8). In one embodiment, the compressed or uncompressed AP vicinity information may be transferred to the mobile device using the LTE Positioning Protocol Extensions (LPPe) protocol defined by the Open Mobile Alliance (OMA). In one embodiment, the mobile device may use the received AP vicinity information to determine its position.

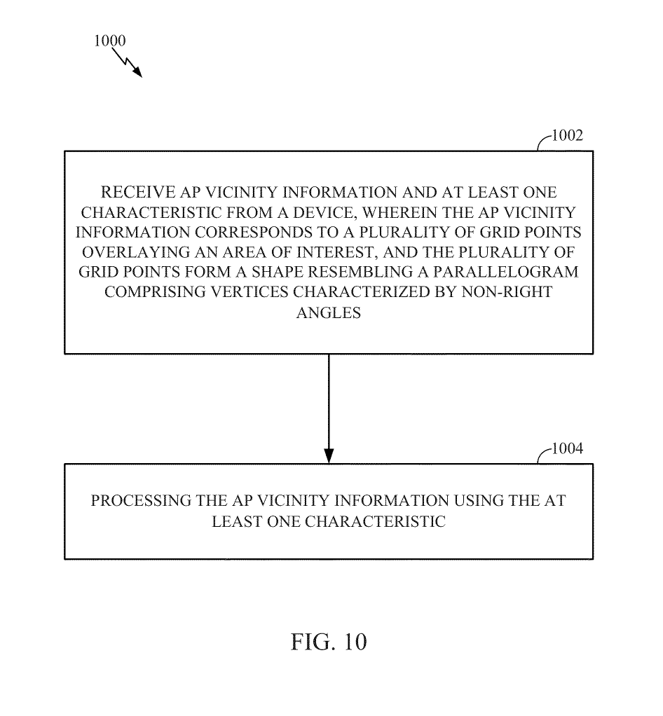

FIG. 10 illustrates example operations of a process 1000 that may be performed by a mobile device (e.g., UE1 108 in FIG. 1) to utilize AP vicinity information, in accordance with certain embodiments of the present disclosure. At 1002, the mobile device receives AP vicinity information and at least one characteristic (e.g., an angle) from a device (e.g., from a location server such as LS 110 in FIG. 1). The AP vicinity information corresponds to a plurality of grid points overlaying an area of interest. The plurality of grid points form a shape resembling a parallelogram including vertices characterized by non-right angles. The AP vicinity information may have been determined by the device using the operations exemplified in FIG. 9. At 1004, the mobile device processes the AP vicinity information using the at least one characteristic. As an example (A) of 1004, the mobile device may receive an uncompressed octet string encoding a sequence of values for some signaling characteristic (e.g., mean RSSI or mean RTT) and may perform a scanning operation that is a reverse to that exemplified in FIG. 5A or FIG. 5B in order to assign encoded values for the signaling characteristic to a rectangular array of grid points. The mobile device may then transform the rectangular array of grid points into an array of grid points resembling a parallelogram by performing a transformation as exemplified in FIG. 7 or FIG. 8 using information received from the device on an angle θ. The mobile device may further associate the encoded value for each grid point in the transformed set of grid points (now resembling a parallelogram) with a particular value for the signaling characteristic for a particular AP at the location of the grid point in the transformed set of grid points. The mobile device may use the values for the signaling characteristic for different grid points along with values for the same signaling characteristic received for heat maps conveyed by the same means for other APs to help determine the location of the mobile device using pattern matching and based on measurements of the signaling characteristic for nearby APs made by the mobile device as described earlier herein.

As another example (B) of operation 1004 in FIG. 10, the mobile device may receive a compressed octet string (e.g., using JPEG) encoding a sequence of values for some signaling characteristic (e.g., mean RSSI or mean RTT) and may perform a decompression operation that is a reverse to that performed by the device to compress the encoded values for the signaling characteristic in order to obtain uncompressed encoded values (e.g., octet values) for the signaling characteristic for a rectangular array of grid points. The mobile device may then transform the rectangular array of grid points into an array of grid points resembling a parallelogram and may associate the encoded value for each grid point in the transformed set of grid points with a particular value for the signaling characteristic for a particular AP at the location of the grid point in the transformed set of grid points as described for example (A) earlier herein. The mobile device may use the values for the signaling characteristic for different grid points to assist in positioning of the mobile device as also described for example (A) herein.

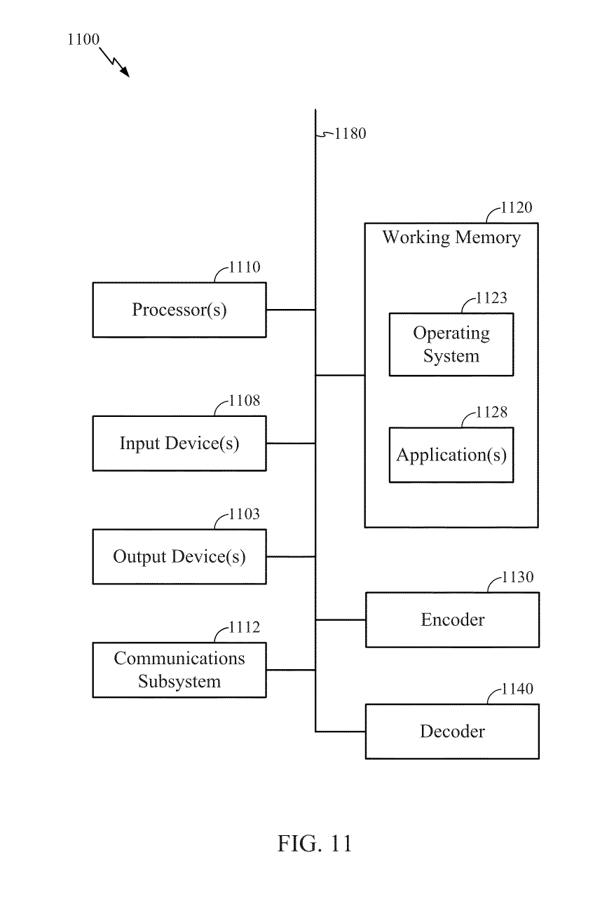

FIG. 11 describes one potential implementation of a device 1100 which may be used to provide or utilize heat map information, according to certain embodiments. In one embodiment, mobile device 108 as described in FIG. 1 may correspond to device 1100 and may be implemented with the specifically described details of process 1000. In another embodiment, location server 110 as described in FIG. 1 may correspond to device 1100 and may be implemented with the specifically described details of process 900. In the embodiment of device 1100 shown in FIG. 11, specialized modules such as encoder 1130 may perform any type of encoding to generate octets representing heat map data (e.g., to support process 900). Device 1100 may also or instead perform decoding of AP vicinity information using a decoder 1140—e.g., if device 1100 is a mobile device and/or to support process 1000. These modules may be implemented to interact with various other modules of device 1100. Memory 1120 may be configured to store data regarding heat maps, and may also store settings and instructions regarding grid orientation, grid size and location, grid spacing, etc.

In the embodiment shown at FIG. 11, the device may be a mobile device or a location server and include processor 1110 configured to execute instructions for performing operations (e.g., to support process 900 and/or process 1000) at a number of components and can be, for example, a general-purpose processor or microprocessor suitable for implementation within a portable electronic device. Processor 1110 may thus implement any or all of the specific steps for operating a compression module as described herein. Processor 1110 is communicatively coupled with a plurality of components within device 1100. To realize this communicative coupling, processor 1110 may communicate with the other illustrated components across a bus 1180. Bus 1180 can be any subsystem adapted to transfer data within device 1100. Bus 1180 can be a plurality of computer buses and include additional circuitry to transfer data.

Memory 1120 may be coupled to processor 1110. In some embodiments, memory 1120 offers both short-term and long-term storage and may in fact be divided into several units. Short term memory may store data which may be discarded after an analysis, or all data may be stored in long term storage depending on user selections. Memory 1120 may be volatile, such as static random access memory (SRAM) and/or dynamic random access memory (DRAM) and/or non-volatile, such as read-only memory (ROM), flash memory, and the like. Furthermore, memory 1120 can include removable storage devices, such as secure digital (SD) cards. Thus, memory 1120 provides storage of computer readable instructions, data structures, program modules, and other data for device 1100. In some embodiments, memory 1120 may be distributed into different hardware modules.

In some embodiments, memory 1120 stores code (e.g., program instructions) for a plurality of applications 1128. Applications 1128 contain particular instructions to be executed by processor 1110. In alternative embodiments, other hardware modules may additionally execute certain applications or parts of applications. Memory 1120 may be used to store computer readable instructions for modules that implement scanning according to certain embodiments, and may also store compact object representations as part of a database.

In some embodiments, memory 1120 includes an operating system 1123. Operating system 1123 may be operable to initiate the execution of the instructions provided by application modules and/or manage other hardware modules as well as interfaces with communications subsystem 1112 which may use a wireless transceiver and an antenna (e.g., if device 1100 is a mobile device) and/or a wireline based transceiver and one or more wireline links (e.g., if device 1100 is a location server). Operating system 1123 may be adapted to perform other operations across the components of device 1100, including threading, resource management, data storage control and other similar functionality.

In some embodiments, device 1100 includes a plurality of other modules (e.g., encoder 1130 and/or decoder 1140). Each of these modules may be a physical module within device 1100 or may be supported as software—e.g., by one or more of applications 1128. As an example, the encoder 1130 may be configured to encode the heat map data as described for process 900. In addition, the decoder 1140 may be configured to decode received heat map data and send them to the processor for further processing—e.g., as described for process 1000.

In certain embodiments, a user may user input devices 1108 (e.g., a keyboard and mouse, a graphical user interface, a microphone) to control creation and/or usage of heat maps—e.g., may select for which APs heat maps are to be created by a location server and for what signaling characteristics. A device 1100 may include a component such as a wireless communications subsystem 1112 which may integrate an antenna and wireless transceiver with any other hardware, firmware, or software necessary for wireless communications. Such a wireless communication subsystem may be configured to receive signals from various devices such as a location server via a wireless network and/or access points such as Wi-Fi access points.

In addition to other hardware modules and applications in memory 1120, a device 1100 may have a display output 1103. Display output 1103 may graphically present information from the device 1100 to a user—e.g., may display for which APs heat maps have been created by a device 1100 that is a server or may display the location of a device 1100 that is a mobile device that is obtained by the device 1100 due to receipt and processing of one or more heat maps. The displayed information may be derived from one or more application modules, one or more hardware modules, a combination thereof, or any other suitable means for resolving graphical content for the user (e.g., by operating system 1123). Display output 1103 can be liquid crystal display (LCD) technology, light emitting polymer display (LPD) technology, or some other display technology. In some embodiments, display output 1103 is a capacitive or resistive touch screen and may be sensitive to haptic and/or tactile contact with a user. In such embodiments, the display output 1103 can comprise a multi-touch-sensitive display.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner.

Specific details are given in the description to provide a thorough understanding of the embodiments. However, embodiments may be practiced without certain specific details. For example, well-known circuits, processes, algorithms, structures, and techniques have been mentioned without unnecessary detail in order to avoid obscuring the embodiments. This description provides example embodiments only, and is not intended to limit the scope, applicability, or configuration of various embodiments. Rather, the preceding description of the embodiments will provide those skilled in the art with an enabling description for implementing embodiments. Various changes may be made in the function and arrangement of elements without departing from the spirit and scope of various embodiments.

Also, some embodiments were described as processes which may be depicted in a flow with process arrows. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks. Additionally, the above elements may merely be a component of a larger system, wherein other rules may take precedence over or otherwise modify the application of various embodiments, and any number of steps may be undertaken before, during, or after the elements of any embodiment are implemented.

Having described several embodiments, it will therefore be clear to a person of ordinary skill that various modifications, alternative constructions, and equivalents may be used without departing from the spirit of the disclosure.

What is claimed is:

1. A method for providing access point (AP) vicinity information, comprising:
defining a plurality of grid points overlaying an area of interest, wherein the plurality of grid points form a shape resembling a parallelogram comprising vertices characterized by non-right angles;
determining AP vicinity information for the plurality of grid points; and
providing the AP vicinity information and at least one characteristic defining the parallelogram to a mobile device.

2. The method of claim 1 wherein the at least one characteristic comprises an angle.

3. The method of claim 1 wherein the plurality of grid points comprises rows of grid points or columns of grid points, and wherein providing the set of AP vicinity information comprises:
mapping the plurality of grid points to form a shape resembling a rectangle by shifting rows of grid point rows or columns of grid points in one direction; and
compressing the AP vicinity information corresponding to the mapped grid points.

4. The method of claim 1 wherein the plurality of grid points comprises rows of grid points, each row comprising an equal number of grid points.

5. The method of claim 4 wherein the at least one characteristic comprises an angle between −45 and 45 degrees.

6. The method of claim 1 wherein the plurality of grid points comprises columns of grid points, each column comprising an equal number of grid points.

7. The method of claim 6 wherein the at least one characteristic comprises an angle between 45 and 90 degrees, or between −90 and −45 degrees.

8. A method for utilizing access point (AP) vicinity information in a mobile device, comprising:
receiving AP vicinity information and at least one characteristic from a device, wherein the AP vicinity information corresponds to a plurality of grid points overlaying an area of interest, and the plurality of grid points form a shape resembling a parallelogram comprising vertices characterized by non-right angles; and
processing the AP vicinity information using the at least one characteristic.

9. The method of claim 8 wherein the at least one characteristic comprises an angle.

10. The method of claim 8 wherein processing the AP vicinity information comprises:
determining AP vicinity information for a plurality of grid points forming a shape resembling a rectangle by decompressing the received AP vicinity information; and
mapping the plurality of grid points into the shape resembling the parallelogram by shifting rows or columns of grid points for the rectangle in one direction according to the at least one characteristic.

11. An apparatus for providing access point (AP) vicinity information, comprising:
means for defining a plurality of grid points overlaying an area of interest, wherein the plurality of grid points form a shape resembling a parallelogram comprising vertices characterized by non-right angles;
means for determining AP vicinity information for the plurality of grid points; and
means for providing the AP vicinity information and at least one characteristic defining the parallelogram to a mobile device.

12. The apparatus of claim 11 wherein the at least one characteristic comprise an angle.

13. The apparatus of claim 11 wherein the plurality of grid points comprises rows of grid points or columns of grid points, and wherein the means for providing the set of AP vicinity information comprises:
means for mapping the plurality of grid points to form a shape resembling a rectangle by shifting rows of grid point rows or columns of grid points in one direction; and
means for compressing the AP vicinity information corresponding to the mapped grid points.

14. The apparatus of claim 13 wherein the plurality of grid points comprises rows of grid points, each row comprising an equal number of grid points.

15. The apparatus of claim 14 wherein the at least one characteristic comprises an angle between −45 and 45 degrees.

16. The apparatus of claim 13 wherein the plurality of grid points comprises columns of grid points, each column comprising an equal number of grid points.

17. The apparatus of claim 16 wherein the at least one characteristic comprises an angle between 45 and 90 degrees, or between −90 and −45 degrees.

18. A non-transitory processor-readable medium for providing access point (AP) vicinity information comprising processor-readable instructions configured to cause a processor to:
define a plurality of grid points overlaying an area of interest, wherein the plurality of grid points form a shape resembling a parallelogram comprising vertices characterized by non-right angles;
determine AP vicinity information for the plurality of grid points; and
provide the AP vicinity information and at least one characteristic defining the parallelogram to a mobile device.

19. The processor-readable medium of claim 18 wherein the at least one characteristic comprises an angle.

20. The processor-readable medium of claim 18 wherein the plurality of grid points comprises rows of grid points or columns of grid points, and wherein the processor-readable instructions are further configured to cause a processor to:
map the plurality of grid points to form a shape resembling a rectangle by shifting rows of grid point rows or columns of grid points in one direction; and
compress the AP vicinity information corresponding to the mapped grid points.

21. The processor-readable medium of claim 18 wherein the plurality of grid points comprises rows of grid points, each row comprising an equal number of grid points.

22. The processor-readable medium of claim 21 wherein the at least one characteristic comprises an angle between −45 and 45 degrees.

23. The processor-readable medium of claim 18 wherein the plurality of grid points comprises columns of grid points, each column comprising an equal number of grid points.

24. The processor-readable medium of claim 23 wherein the at least one characteristic comprises an angle between 45 and 90 degrees, or between −90 and −45 degrees.
